(19) United States
(12) Patent Application Publication
(10) Pub. No.: US 2019/0078227 A1
(43) Pub. Date: Mar. 14, 2019

(54) THERMAL STRESS COMPENSATION BONDING LAYERS AND POWER ELECTRONICS ASSEMBLIES INCORPORATING THE SAME

(71) Applicant: Toyota Motor Engineering & Manufacturing North America, Inc., Erlanger, KY (US)

(72) Inventors: Shailesh N. Joshi, Ann Arbor, MI (US); Ercan Mehmet Dede, Ann Arbor, MI (US)

(21) Appl. No.: 15/700,723

(22) Filed: Sep. 11, 2017

(51) Int. Cl. C25D 7/12; B23K 35/30

(52) U.S. Cl. CPC C25D 7/12; B23K 35/3033

(57) ABSTRACT

A thermal stress compensation layer includes a metal inverse opal (MIO) layer with a plurality of hollow spheres and a predefined porosity disposed between a pair of bonding layers. The thermal stress compensation layer has a melting point above a TLP sintering temperature and the pair of bonding layers each have a melting point below the TLP sintering temperature such that the MIO layer can be transient liquid phase bonded between a metal substrate and a semiconductor device. The pair of bonding layers may comprise a first pair of bonding layers and a second pair of bonding layers with the first pair of bonding layers disposed between the MIO layer and the second pair of bonding layers. The first pair of bonding layers may have a melting point above the TLP sintering temperature and the second pair of bonding layers may have a melting point below the TLP sintering temperature.

### TECHNICAL FIELD

The present specification generally relates to bonding materials, and more particularly, to thermal stress compensation bonding materials for bonding of semiconductor devices to metal substrates during the manufacture of power electronics assemblies.

### BACKGROUND

Power electronics devices are often utilized in high-power electrical applications, such as inverter systems for hybrid electric vehicles and electric vehicles. Such power electronics devices include power semiconductor devices, such as power IGBTs and power transistors thermally bonded to a metal substrate. The metal substrate may then be further thermally bonded to a cooling structure, such as a heat sink.

With advances in battery technology and increases in electronics device packaging density, operating temperatures of power electronics devices have increased and are currently approaching 200° C. Accordingly, traditional electronic device soldering techniques no longer provide suitable bonding of semiconductor devices to metal substrates and alternative bonding techniques are needed. One such alternative bonding technique is transient liquid phase (TLP) sintering (also referred to herein as “TLP bonding”). The TLP sintering of a power electronics device utilizes a bonding layer disposed (sandwiched) between a semiconductor device and metal substrate. The bonding layer at least partially melts and isothermally solidifies to form a TLP bond between the semiconductor device and metal substrate at TLP bonding temperatures (also referred to as sintering temperatures) between about 280° C. to about 350° C. The semiconductor devices and metal substrates have different coefficients of thermal expansion (CTE) and large thermally-induced stresses (e.g., cooling stresses) may be generated between a semiconductor device and metal substrate upon cooling from a TLP sintering temperature. The large thermal cooling stresses due to CTE mismatch between the power semiconductor device and metal substrate may result in delamination between the semiconductor device and metal substrate of a power electronics device when currently known bonding layers are used to form the TLP bond.

### SUMMARY

In one embodiment, a transient liquid phase (TLP) bonding layer includes a thermal stress compensation layer disposed between a pair of bonding layers. The thermal stress compensation layer comprises a metal inverse opal (MIO) layer with a plurality of hollow spheres and a predefined porosity. The thermal stress compensation layer has a melting point above a TLP sintering temperature and the pair of bonding layers each have a melting point below the TLP sintering temperature. In embodiments, the MIO layer includes a first surface, a second surface and a graded porosity between the first surface and the second surface. In the alternative, or in addition to, the MIO layer comprises a graded stiffness between the first surface and the second surface. The pair of bonding layers may comprise a first pair of bonding layers and a second pair of bonding layers with the first pair of bonding layers disposed between the MIO layer and the second pair of bonding layers. Each of the first pair of bonding layers may have a melting point above the TLP sintering temperature and each of the second pair of bonding layers may have a melting point below the TLP sintering temperature. In embodiments, the MIO layer is a copper inverse opal (CIO) layer, the first pair of bonding layers are formed from nickel, silver or alloys thereof, and the second pair of bonding layers are formed from tin, indium, or alloys thereof.

In another embodiment, a power electronics assembly includes a semiconductor device extending across a metal substrate and a thermal stress compensation layer disposed between and bonded to the semiconductor device and the metal substrate. The thermal stress compensation layer comprises an MIO layer with a plurality of hollow spheres and a predefined porosity. In some embodiments, the thermal stress compensation layer is TLP bonded to the semiconductor device and the metal substrate. In such embodiments, the MIO layer has a melting point above a TLP sintering temperature and the pair of bonding layers each have a melting point below the TLP sintering temperature. In embodiments, the MIO layer includes a first surface, a second surface and a graded porosity between the first surface and the second surface. In the alternative, or in addition to, the MIO layer comprises a graded stiffness between the first surface and the second surface. The pair of bonding layers may include a first pair of bonding layers and a second pair of bonding layers with the first pair of bonding layers disposed between the MIO layer and the second pair of bonding layers. Each of the first pair of bonding layers may have a melting point above the TLP sintering temperature and each of the second pair of bonding layers may have a melting point below the TLP sintering temperature. In embodiments, the MIO layer is a copper inverse opal (CIO) layer, the first pair of bonding layers are formed from nickel, silver or alloys thereof, and the second pair of bonding layers are formed from tin, indium, or alloys thereof.

In yet another embodiment, a process for manufacturing a power electronics assembly includes positioning a thermal stress compensation layer between a metal substrate and a semiconductor device to provide a metal substrate/semiconductor device assembly. The thermal stress compensation layer comprises an MIO layer. In some embodiments, the thermal stress compensation layer includes a pair of bond layers with the MIO layer disposed between the pair of bond layers. In such embodiments, the process may include heating the metal substrate/semiconductor device assembly to a transient liquid phase (TLP) sintering temperature between about 280° C. and 350° C. The pair of bonding layers each have a melting point less than the TLP sintering temperature and the MIO layer has a melting point greater than the TLP sintering temperature such that the pair of bonding layers at least partially melt and form a TLP bond between the metal substrate and the MIO layer, and between the semiconductor device and the MIO layer. The pair of bonding layers may comprise a first pair of bonding layers and a second pair of bonding layers with the first pair of bonding layers disposed between the MIO layer and the second pair of bonding layers. Each of the first part of bonding layers have a melting point above the TLP sintering temperature and each of the second pair of bonding layers each have the melting point below the TLP sintering temperature such that the second pair of bonding layers at least partially melt and form a TLP bond with the first pair of bonding layers, the metal substrate and the semiconductor device. In other embodiments, the process includes placing the metal substrate/semiconductor device assembly in an electrolytic or electroless plating bath and bonding the MIO layer to the metal substrate and the semiconductor device via an electroplating or electroless plating bonding layer.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a side view of a power electronics assembly having a power semiconductor device bonded to a metal substrate with a thermal stress compensation layer according to one or more embodiments shown and described herein;

FIG. 2 schematically depicts an exploded view of the thermal stress compensation layer in FIG. 1 according to one or more embodiments shown and described herein;

FIG. 3 graphically depicts normalized Young's modulus as a function of porosity in a metal inverse opal layer;

FIG. 4 schematically depicts the thermal stress compensation layer in FIG. 2 transient liquid phase bonded the power semiconductor device and metal substrate in FIG. 1;

FIG. 5 schematically depicts an exploded view of the thermal stress compensation layer in FIG. 1 according to one or more embodiments shown and described herein;

FIG. 6 schematically depicts the thermal stress compensation layer in FIG. 5 transient liquid phase bonded the power semiconductor device and metal substrate in FIG. 1;

FIG. 7 schematically depicts a process of bonding a thermal stress compensation layer to a power semiconductor device and a metal substrate according to one or more embodiments shown and described herein; and

FIG. 8 schematically depicts a vehicle having a plurality of power electronics assemblies according to one or more embodiments shown and described herein.

### DETAILED DESCRIPTION

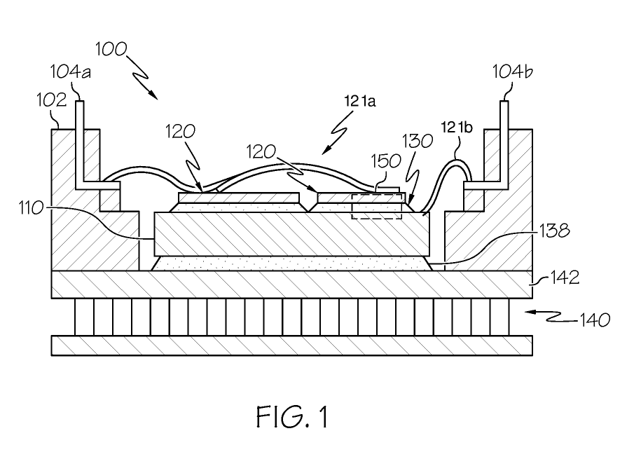

FIG. 1 generally depicts one embodiment of a power electronics assembly. The power electronics assembly comprises a power semiconductor device (semiconductor device) thermally bonded to a metal substrate with a thermal compensation layer that compensates for thermally-induced stresses generated or resulting from fabrication and operation of the power electronics assembly. The thermally-induced stresses are due to coefficient of thermal expansion (CTE) mismatch between the semiconductor device and metal substrate of the power electronics assembly. The thermal compensation layer comprises a metal inverse opal (MIO) layer with a plurality of hollow spheres and a predefined porosity. The thermal stress compensation layer may include a pair of bonding layers that extend across the MIO layer such that the MIO layer is disposed between the pair of bonding layers. The MIO layer has a melting point that is greater than a transient liquid phase (TLP) sintering temperature and the pair of bonding layers have a melting point that is less than the TLP sintering temperature used to form a TLP bond between the semiconductor device, the MIO layer and the metal substrate. Various embodiments of thermal stress compensation materials and power electronics assemblies using thermal stress compensation layers will be described in more detail herein.

Referring initially to FIG. 1, one embodiment of a power electronics assembly 100 is illustrated. The power electronics assembly 100 generally comprises a metal substrate 110, two semiconductor devices 120 bonded to the metal substrate 110 via a thermal stress compensation layer 130, a cooling structure 140, and a package housing 102.

The thicknesses of the metal substrate 110 and the semiconductor devices 120 may depend on the intended use of the power electronics assembly 100. In one embodiment, the metal substrate 110 has a thickness within the range of about 2.0 mm to about 4.0 mm, and the semiconductor device 120 has a thickness within the range of about 0.1 mm to about 0.3 mm. For example and without limitation, the metal substrate may have a thickness of about 3.0 mm and the semiconductor device 120 may have a thickness of about 0.2 mm. It should be understood that other thicknesses may be utilized.

The metal substrate 110 may be formed from a thermally conductive material such that heat from the semiconductor devices 120 is transferred to the cooling structure 140. The metal substrate may be formed copper (Cu), e.g., oxygen free Cu, aluminum (Al), Cu alloys, Al alloys, and the like. The semiconductor devices 120 may be formed from a wide band gap semiconductor material suitable for the manufacture or production of power semiconductor devices such as power IGBTs and power transistors. In embodiments, the semiconductor devices 120 may be formed from wide band gap semiconductor materials including without limitation silicon carbide (SiC), silicon dioxide (SiO₂), aluminum nitride (AlN), gallium nitride (GaN), boron nitride (BN), diamond, and the like. In embodiments, the metal substrate 110 and the semiconductor devices 120 may comprise a coating, e.g., nickel (Ni) plating, to assist in the TLP sintering of the semiconductor devices 120 to the metal substrate 110.

As depicted in FIG. 1, a metal substrate 110 is bonded to two semiconductor devices 120 via the thermal stress compensation layer 130. More or fewer semiconductor devices 120 may be attached to the metal substrate 110. In some embodiments, heat generating devices other than power semiconductor devices may be attached to the metal substrate 110. The semiconductor devices 120 may be power semiconductor devices such as insulated-gate bipolar transistors (IGBTs), power diodes, power metal-oxide-semiconductor field-effect transistors (MOSFETs), power transistors, and the like. In one embodiment, the semiconductor devices 120 of one or more power electronics assemblies are electrically coupled to form an inverter circuit or system for vehicular applications, such as for hybrid vehicles or electric vehicles, for example.

The metal substrate 110 is thermally coupled to the cooling structure 140 via a bond layer 138. In one embodiment, the cooling structure 140 comprises an air-cooled heat sink. In an alternative embodiment, the cooling structure 140 comprises a liquid-cooled heat sink, such as a jet impingement or channel-based heat sink device. The metal substrate 110 of the illustrated embodiment is directly bonded to a first surface 142 of the cooling structure 140 via the bond layer 138 without any additional interface layers (e.g., additional metal base plates). The metal substrate 110 may be bonded to the cooling structure 140 using a variety of bonding techniques, such as by TLP sintering, solder, brazing, or diffusion bonding, for example. However, in an alternative embodiment, one or more thermally conductive interface layers may be positioned between the metal substrate 110 and the cooling structure 140.

Still referring to FIG. 1, the metal substrate 110 may be maintained within a package housing 102, which may be made of a non-electrically conductive material such as plastic, for example. The package housing 102 may be coupled to the cooling structure 140 by a variety of mechanical coupling methods, such as by the use of fasteners or adhesives, for example.

Within the power electronics assembly 100 may be a first electrical contact 104a and a second electrical contact 104b to provide electrical power connections to the semiconductor devices 120. The first electrical contact 104a may correspond to a first voltage potential and the second electrical contact 104b may correspond to a second voltage potential. In the illustrated embodiment, the first electrical contact 104a is electrically coupled to a first surface of the semiconductor devices 120 via a first electrical wire 121a, and the second electrical contact 104b is electrically coupled to a second surface of the semiconductor devices 120 via a second electrical wire 121b and the metal substrate 110. It should be understood that other electrical and mechanical configurations are possible, and that embodiments are not limited by the arrangement of the components illustrated in the figures.

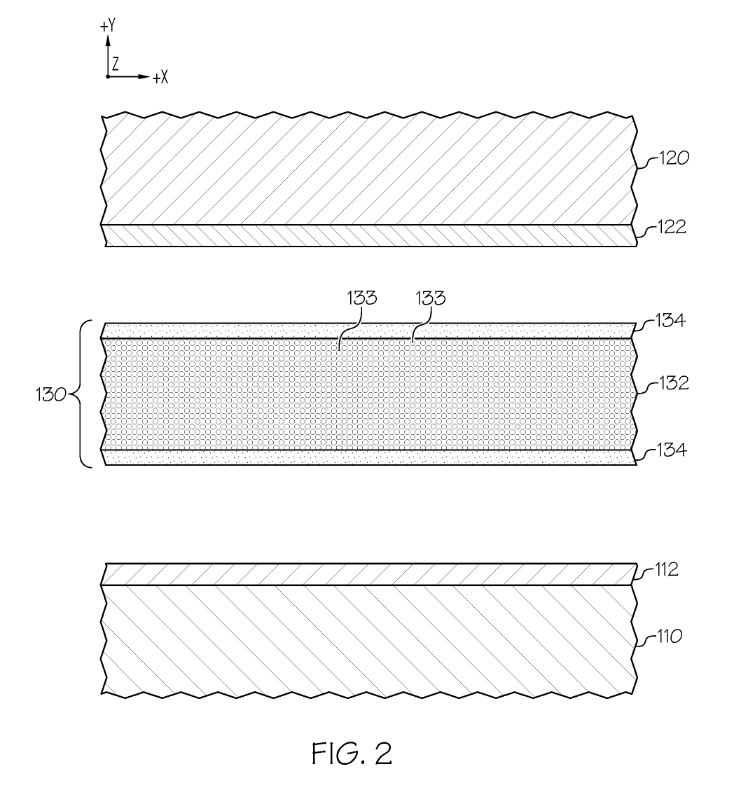

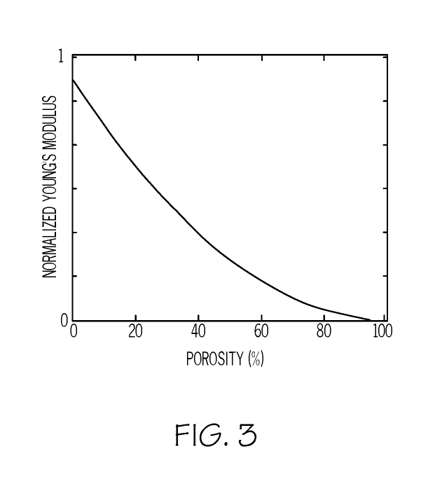

Referring now to FIG. 2, an exploded view of the region designated by box 150 in FIG. 1 before bonding the semiconductor devices 120 to the metal substrate 110 is schematically depicted. In embodiments, the semiconductor device 120 is TLP bonded to the metal substrate 110. In such embodiments, the metal substrate 110 may include a bonding layer 112, the semiconductor device 120 may include a bonding layer 122, and the thermal stress compensation layer 130 comprises an MIO layer 132 and a pair of bonding layers 134. The MIO layer 132 may be disposed between and in direct contact with the pair of bonding layers 134. The MIO layer 132 has a plurality of hollow spheres 133 and a predefined porosity. In embodiments, a stiffness for the MIO layer 132 is a function of the porosity, i.e., the amount of porosity, of the MIO layer 132. As used herein, the term stiffness refers to the elastic modulus (also known as Young's modulus) of a material, i.e., a measure of a material's resistance to being deformed elastically when a force is applied to the material. The MIO layer 132 may be formed by depositing metal within a sacrificial template of packed microspheres and then dissolving the microspheres to leave a skeletal network of metal with a periodic arrangement of interconnected hollow spheres which may or may not be etched to increase the porosity and interconnection of the hollow spheres pores. The skeletal network of metal has a large surface area and the amount of porosity of the MIO layer 132 can be varied by changing the size of the sacrificial microspheres. Also, the size of the microspheres and thus the size of the hollow spheres can be varied as a function of thickness (Y direction) of the MIO layer 132 such that a graded porosity, i.e., graded hollow sphere diameter, is provided as a function of thickness is provided. As noted above, the Young's modulus (stiffness) of a MIO layer may be a function of porosity in a MIO layer. For example, FIG. 3 graphically depicts the Young's modulus of a MIO layer as a function of porosity. Accordingly, the stiffness of the MIO layer 132 can be varied and controlled to accommodate thermal stress for a given semiconductor device 120—metal substrate 110 combination. Also, a graded stiffness along the thickness of the MIO layer 132 can be provided to accommodate thermal stress for a given semiconductor device 120—metal substrate 110 combination.

The pair of bonding layers 134 have a melting point that is less than a melting point of the MIO layer 132. Particularly, the pair of bonding layers 134 have a melting point that is less than a TLP sintering temperature used to TLP bond the semiconductor device 120 to the metal substrate 110, and the MIO layer 132 has a melting temperature that is greater than the TLP sintering temperature. As a non-limiting example, the TLP sintering temperature is between about 280° C. and about 350° C., and the pair of bonding layers 134 have a melting point less than about 280° C. and the MIO layer 132 has melting points greater than 350° C. For example, the pair of bonding layers 134 may be formed from tin (Sn) with a melting point of about 232° C., whereas the MIO layer 132 may be formed any material that can be electrolytic or electroless deposited. Non-limiting examples include materials such as Cu, Ni, Al, silver (Ag), zinc (Zn) and magnesium (Mg) with a melting point of about 1085° C., 660° C., 962° C., 420° C. and 650° C., respectively. Accordingly, the pair of bonding layers 134 at least partially melt and the MIO layer 132 does not melt during TLP sintering of the semiconductor device 120 to the metal substrate 110.

The thermal stress compensation layer 130 described herein compensates thermally-induced stresses, e.g., thermal cooling stresses, resulting from fabrication (e.g., TLP sintering) and operational conditions (e.g., transient electric loads causing high changes in temperature). Because the metal substrate 110 and semiconductor devices 120 of the power electronics assembly 100 are made of differing materials, differences in the CTE for each material may cause large thermally-induced stresses within the metal substrate 110, semiconductor devices 120 and thermal stress compensation layer 130. It should be understood that the large thermally-induced stresses may result in failure of the power electronics assembly 100 due to fracturing of the metal substrate 110 or failure of a traditional TLP bonding material (e.g., delamination) between the metal substrate 110 and one or both of the semiconductor devices 120.

The use of the thermal stress compensation layer 130 to TLP bond the metal substrate 110 to the semiconductor devices 120 alleviates or mitigates such stresses. That is, the thermal stress compensation layer 130 described herein compensates for the thermal expansion and contraction experienced by the metal substrate 110 and semiconductor devices 120. In some embodiments, the thermal stress compensation layer 130 described herein compensates for the thermal expansion and contraction experienced by the metal substrate 110 and semiconductor devices 120 with the MIO layer 132 having a generally constant stiffness between the metal substrate 110 and semiconductor devices 120. In other embodiments, the thermal stress compensation layer 130 described herein compensates for the thermal expansion and contraction experienced by the metal substrate 110 and semiconductor devices 120 with the MIO layer 132 having a graded stiffness across its thickness. That is, a varied hollow sphere size (average diameter) across the thickness of the MIO layer 132 provides a graded porosity and thus a graded stiffness across the thickness of the MIO layer 132. The MIO layer 132, with the constant stiffness or the graded porosity across its thickness, allows the thermal stress compensation layer 130 to plastically deform and not delaminate due to the CTE mismatch between the metal substrate 110 and semiconductor devices 120. Also, the MIO layer 132 provides sufficient stiffness such that the semiconductor devices 120 are adequately secured to the metal substrate 110 for subsequent manufacturing steps performed on the semiconductor devices 120. The thermal stress compensation layer 130 also provides sufficient high temperature bonding strength between the metal substrate 110 and semiconductor devices 120 during operating temperatures approaching and possibly exceeding 200° C.

Generally, the MIO layer 132 comprises a flat thin layer and the pair of bonding layers 134 comprise flat thin films. As non-limiting examples, the thickness of the MIO layer 132 may be between about 25 micrometers (microns) and about 200 microns. In embodiments, the MIO layer 132 has a thickness between about 50 microns and about 150 microns. In other embodiments, the MIO layer 132 has a thickness between about 75 microns and 125 microns, for example a thickness of 100 microns. The thickness of the pair of bonding layers 134 may be between 1 micron and 20 microns. In embodiments, the pair of bonding layers 134 each have a thickness between about 2 microns and about 15 microns.

The thermal stress compensation layer 130 may be formed using conventional multilayer thin film forming techniques illustratively including but not limited to chemical vapor depositing the pair of bonding layers 134 onto the MIO layer 132, physical vapor depositing the pair of bonding layers 134 on the MIO layer 132, electrolytically depositing the pair of bonding layers 134 onto the MIO layer 132, electroless depositing the pair of bonding layers 134 onto the MIO layer 132, and the like.

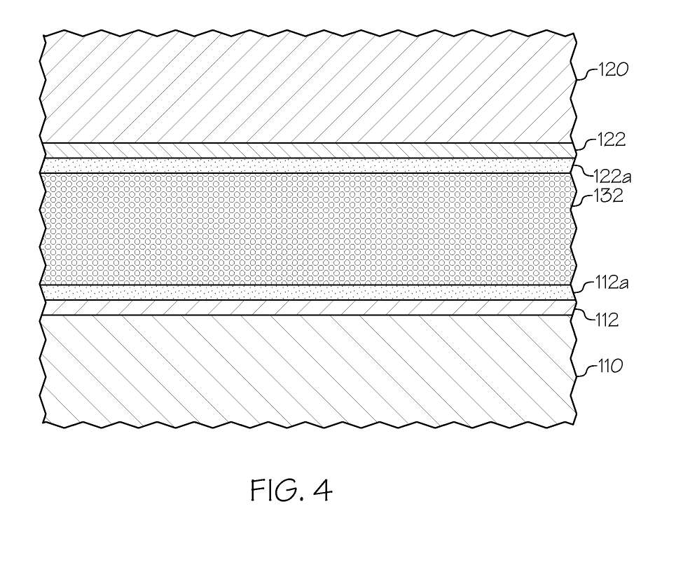

Referring now to FIG. 4, an enlarged view of the region designated by box 150 in FIG. 1 after the semiconductor devices 120 have been TLP bonded to the metal substrate 110 is schematically depicted. As illustrated in FIG. 4, the MIO layer 132 remains as in FIG. 2, i.e., the MIO layer 132 does not melt during the TLP bonding process and generally remains the same thickness as before the TLP bonding process. In contrast, the pair of bonding layers 134 at least partially melt, diffuse into the bonding layers 112, 122 and the MIO layer 132, and form TLP bond layers 112a and 122a. Although TLP bond layers 112a and 122a depicted in FIG. 4 have consumed the bonding layers 134, in embodiments the TLP bond layers 112a and/or 122a may not totally consume the bonding layers 134, i.e., a thin layer of the bonding layers 134 may be present after the thermal stress compensation layer 130 is TLP bonded between the semiconductor devices 120 and the metal substrate 110. In other embodiments, both the bonding layers 134 and the bonding layers 112, 122 are consumed by the TLP bond layers 112a, 122a, i.e., only the TLP bond layers 112a and/or 122a are present between the MIO layer 132 and the metal substrate 110 and/or semiconductor devices 120, respectively. In still other embodiments, the TLP bond layers 112a and/or 122a may comprise no layers, i.e., all of the bonding layers 134, 112 and 122 diffuse into the MIO layer 132, metal substrate 110 and/or semiconductor device 120 thereby resulting in a clearly defined TLP bond layer 112a and/or 122a not being present.

In embodiments, the MIO layer 132 is formed from copper, i.e., the MIO layer 132 is a copper inverse opal (CIO) layer 132. In such embodiments, the pair of bonding layers 134 may be formed from Sn, the bonding layers 112, 122 may be formed from nickel (Ni), and the TLP bond layers 112a and 122a comprise an intermetallic layer of Cu and Sn. In some embodiments, the TLP bond layers 112a and 122a comprise an intermetallic layer of Cu, Ni and Sn. For example and without limitation, the TLP bond layers 112a and 122a may include the intermetallic Cu₆Sn₅, the intermetallic (Cu, Ni)₆Sn₅, the intermetallic Cu₃Sn or a combination of the intermetallics Cu₆Sn₅, (Cu, Ni)₆Sn₅, and/or Cu₃Sn. It should be understood that the bonding layers 134 formed from Sn at least partially melt at the TLP sintering temperature and then isothermally solidify during the formation of the Cu-Sn intermetallic(s) since Cu₆Sn₅ starts to melt at 415° C. and Cu₃Sn starts to melt at about 767° C. That is, a melting temperature of the TLP bond layers 112a, 122a is greater than a melting temperature of the pair of bonding layers 134.

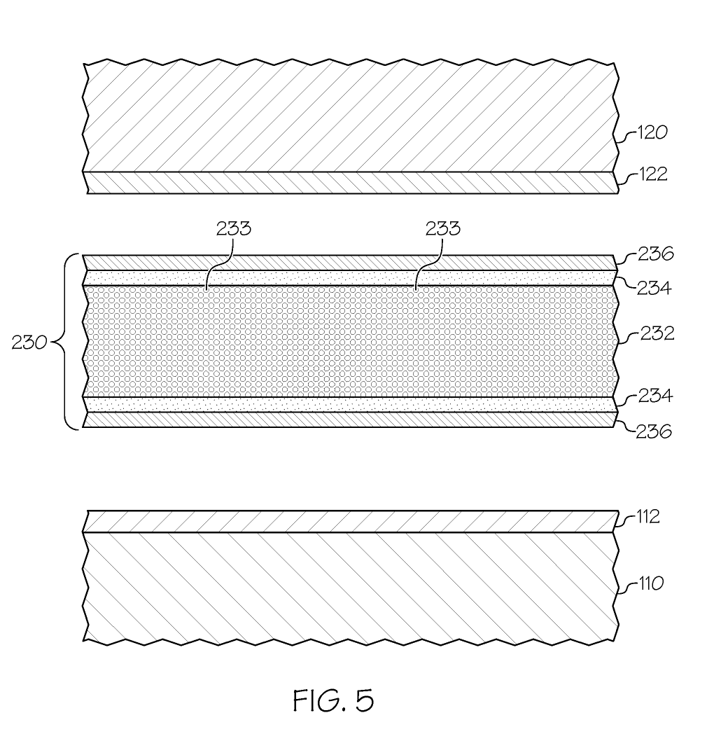

Referring now to FIG. 5, an exploded view of the region designated by box 150 in FIG. 1 before TLP sintering of the semiconductor devices 120 to the metal substrate 110 according to another embodiment is schematically depicted. Particularly, a thermal stress compensation layer 230 comprises an MIO layer 232, a first pair of bonding layers 234 and a second pair of bonding layers 236. The MIO layer 232 may be disposed between and in direct contact with the first pair of bonding layers 234 and the first pair of bonding layers 234 may be disposed between and in direct contact with the second pair of bonding layers 236. The MIO layer 232 has a plurality of hollow spheres 233 and a predefined porosity that provides a stiffness for the MIO layer 232.

The MIO layer 232 and each of the first pair of bonding layers 234 have melting points greater than a TLP sintering temperature and each of the second pair of bonding layers 236 have a melting point that is less than the TLP sintering temperature used to form a TLP bond between the metal substrate 110 and semiconductor devices 120. As a non-limiting example, the TLP sintering temperature is between about 280° C. and about 350° C. and each of the second pair of bonding layers 236 have a melting point less than about 280° C. and each of the MIO layer 232 and first pair of bonding layers 234 have melting points greater than 350° C. For example, the second pair of bonding layers 236 may be formed from Sn with a melting point of about 232° C., whereas MIO layer 232 and first pair of bonding layers 234 may be formed from materials such as Cu, Al, Ag, Zn, and Mg with a melting point of about 1085° C., 660° C., 962° C., 420° C. and 650° C., respectively. Accordingly, the second pair of bonding layers 236 at least partially melt and the MIO layer 232 and the first pair of bonding layers 234 do not melt during TLP bonding of the semiconductor devices 120 to the metal substrate 110.

The thermal stress compensation layer 230 may be formed using conventional multilayer thin film forming techniques illustratively including but not limited to chemical vapor depositing the first pair of bonding layers 234 and the second pair of bonding layers 236 onto the MIO layer 232, physical vapor depositing the first pair of bonding layers 234 and the second pair of bonding layers 236 onto the MIO layer 232, electrolytically depositing the first pair of bonding layers 234 and the second pair of bonding layers 236 onto the MIO layer 232, electroless depositing the first pair of bonding layers 234 and the second pair of bonding layers 236 onto the MIO layer 232, and the like.

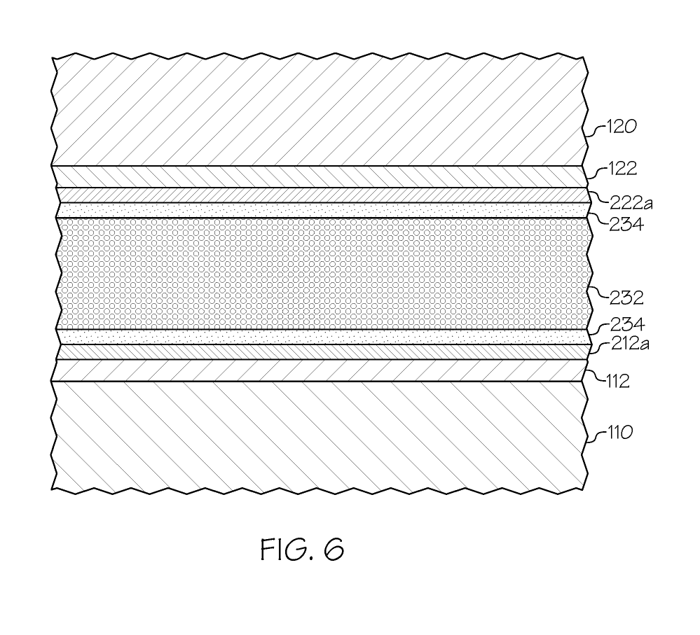

Referring now to FIG. 6, an enlarged view of the region designated by box 150 in FIG. 1 after the semiconductor devices 120 have been TLP bonded to the metal substrate 110 with the thermal stress compensation layer 230 is schematically depicted. As illustrated in FIG. 6, after the semiconductor devices 120 have been TLP bonded to the metal substrate 110, the MIO layer 232 and the first pair of bonding layers 234 remain as in FIG. 5, i.e., the MIO layer 232 and the first pair of bonding layers 234 do not melt during the TLP bonding process and generally remain the same thickness as before the TLP bonding process. In contrast, the second pair of bonding layers 236 at least partially melt and form TLP bond layers 212a and 222a. Although TLP bond layers 212a and 222a depicted in FIG. 6 each comprise one layer, in embodiments the TLP bond layers 212a and/or 222a may comprise two or more layers between the bonding layer 110 and adjacent first bonding layer 234, and the bonding layer 122 and adjacent first bonding layer 234, respectively. In other embodiments, the TLP bond layers 212a and/or 222a may comprise no layers, i.e., all of the bonding layers 234, 112 and 122 diffuse into the MIO layer 232, metal substrate 110 and/or semiconductor device 120 thereby resulting in a clearly defined TLP bond layer 212a and/or 222a not being present.

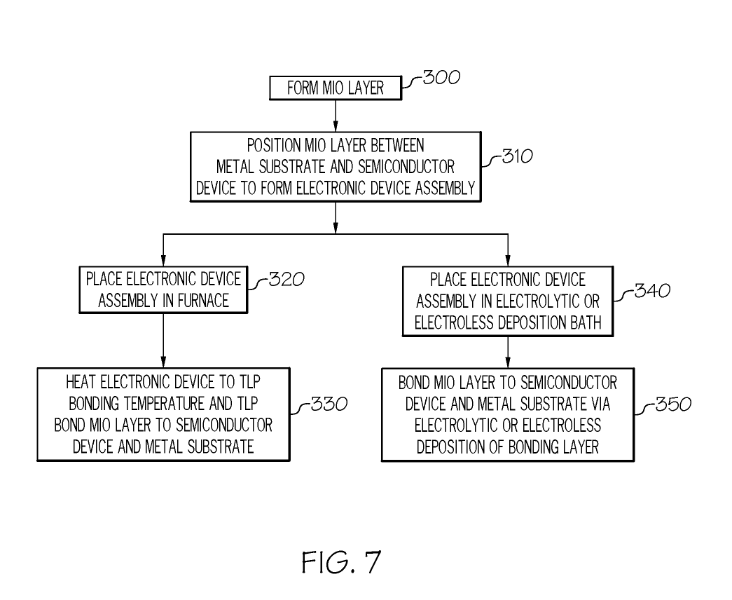

Referring now to FIG. 7, processes for bonding a power semiconductor device to a metal substrate with a thermal stress compensation layer are depicted. Particularly, at step 300 an MIO layer is formed as described above and a thermal compensation layer is positioned between the metal substrate 110 and the semiconductor device 120 at step 310 to form an electronic device assembly. In some embodiments, the thermal compensation layer is TLP bonded between the metal substrate 110 and the semiconductor device 120. In such embodiments, the thermal stress compensation layer 130 is disposed between the pair of bonding layers 134 (FIG. 2), or in the alternative, the thermal stress compensation layer 230 is disposed between a pair of first bonding layers 234, which are disposed between a pair of second pair of bonding layers 236 (FIG. 5). At step 310 the thermal stress compensation layer 130 (or the thermal stress compensation layer 230) is brought into direct contact with the metal substrate 110 and the semiconductor device 120 to form the electronic device assembly. In some embodiments, a force F is applied to the semiconductor device 120 in order to ensure contact between the bonding layer 112, the thermal stress compensation layer 130 and the bonding layer 122 is maintained during the TLP bonding process. Also, the force F may ensure the semiconductor device 120 does not move relative to the metal substrate 110 during the TLP bonding process. The electronic device assembly is placed in a furnace at step 320. At step 330 the electronic device assembly is heated to a TLP sintering temperature and the pair of bonding layers 134 at least partially melt and form the TLP bond layer 112a between the MIO layer 132 and the metal substrate 110 and the TLP bond layer 122a between the MIO layer 132 and the semiconductor 120. After heating to the TLP sintering temperature, the metal substrate/semiconductor device assembly is cooled to ambient temperature. As used herein, the term “ambient temperature” refers to room temperature, e.g., to a temperature less than about 25° C. such as between about 20° C. and 22° C. It should be understood that the furnace for heating to electronic device assembly to the TLP sintering temperature may comprise an inert or reducing gas atmosphere. Illustrative examples of inert gas atmospheres include but are not limited to atmospheres of helium, argon, neon, xenon, krypton, radon and combinations thereof. Illustrative examples of reducing gas atmospheres include but are not limited to hydrogen, argon plus hydrogen, helium plus hydrogen, neon plus hydrogen, xenon plus hydrogen, krypton plus hydrogen, radon plus hydrogen, and combinations thereof.

In other embodiments, the thermal stress compensation layer 130 (or thermal stress compensation layer 230) is electroplate bonded or electroless plate bonded between the metal substrate 110 and the semiconductor device 120. In such embodiments, the electronic device assembly is placed in a electroplating bath or an electroless plating bath at step 340 and the MIO layer 132 is electroplate bonded or electroless plate bonded to the metal substrate 110 and the semiconductor device 120 at step 350 via electrolytic or electroless deposition of a bonding layer.

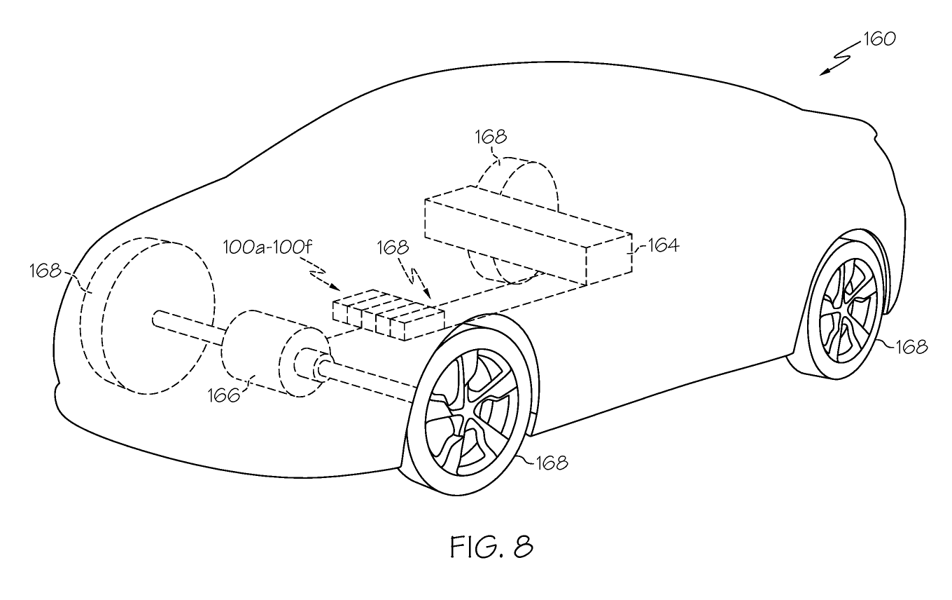

As stated above, the metal substrates and power electronics assemblies described herein may be incorporated into an inverter circuit or system that converts direct current electrical power into alternating current electrical power and vice versa depending on the particular application. For example, in a hybrid electric vehicle application as illustrated in FIG. 8, several power electronics assemblies 100a-100f may be electrically coupled together to form a drive circuit that converts direct current electrical power provided by a bank of batteries 164 into alternating electrical power that is used to drive an electric motor 166 coupled to the wheels 168 of a vehicle 160 to propel the vehicle 160 using electric power. The power electronics assemblies 100a-100f used in the drive circuit may also be used to convert alternating current electrical power resulting from use of the electric motor 166 and regenerative braking back into direct current electrical power for storage in the bank of batteries 164.

Power semiconductor devices utilized in such vehicular applications may generate a significant amount of heat during operation, which require bonds between the semiconductor devices and metal substrates that can withstand higher temperatures and thermally-induced stresses due to CTE mismatch. The thermal stress compensation layers described and illustrated herein may compensate for the thermally-induced stresses generated during thermal bonding of the semiconductor devices to the metal substrate and/or operation of the power semiconductor devices with a constant or graded stiffness across the thickness of the thermal stress compensation layers while also providing a compact package design.

It should now be understood that the multilayer composites incorporated into the power electronics assemblies and vehicles described herein may be utilized to compensate thermally-induced stresses due to CTE mismatch without the need for additional interface layers, thereby providing for a more compact package design with reduced thermal resistance.

It is noted that the terms “about” and “generally” may be utilized herein to represent the inherent degree of uncertainty that may be attributed to any quantitative comparison, value, measurement, or other representation. This term is also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. A transient liquid phase (TLP) bonding layer comprising:
a thermal stress compensation layer disposed between at least one pair of bonding layers, the thermal stress compensation layer comprising a metal inverse opal (MIO) layer with a plurality of hollow spheres and a predefined porosity;
wherein the thermal stress compensation layer has a melting point above a TLP sintering temperature and the at least one pair of bonding layers each have a melting point below the TLP sintering temperature.

2. The TLP bonding layer of claim 1, wherein the MIO layer comprises a first surface, a second surface and a graded porosity between the first surface and the second surface.

3. The TLP bonding layer of claim 1, wherein the MIO layer comprises a first surface, a second surface and a graded stiffness between the first surface and the second surface.

4. The TLP bonding layer of claim 1, wherein:
the at least one pair of bonding layers comprise a first pair of bonding layers and a second pair of bonding layers, wherein:
the first pair of bonding layers are disposed between the MIO layer and the second pair of bonding layers;
each of the first pair of bonding layers have a melting point above the TLP sintering temperature; and
each of the second pair of bonding layers have a melting point below the TLP sintering temperature.

5. The TLP bonding layer of claim 4, wherein the MIO layer is a copper inverse opal (CIO) layer, the first pair of bonding layers are formed from nickel, silver or alloys thereof, and the second pair of bonding layers are formed from tin, indium or alloys thereof.

6. The TLP bonding layer of claim 1, wherein the MIO layer has a thickness between about 50 microns and about 150 microns.

7. The TLP bonding layer of claim 1, wherein the plurality of hollow spheres have an average diameter between about 5 μm and about 50 μm.

8. The TLP bonding layer of claim 1, wherein the pair of bonding layers each have a thickness between about 2 microns and about 10 microns.

9. A power electronics assembly comprising:
a metal substrate;
a semiconductor device; and
a thermal stress compensation layer disposed between and bonded to the semiconductor device and the metal substrate, the thermal stress compensation layer comprising a metal inverse opal (MIO) layer with a plurality of hollow spheres and a predefined porosity.

10. The power electronics assembly of claim 9, wherein the MIO layer comprises a first surface, a second surface and a graded porosity between the first surface and the second surface.

11. The power electronics assembly of claim 9, wherein the MIO layer comprises a first surface, a second surface and a graded stiffness between the first surface and the second surface.

12. The power electronics assembly of claim 9, wherein the plurality of hollow spheres have an average diameter between about 5 μm and about 50 μm.

13. The power electronics assembly of claim 9, further comprising a pair of bond layers, wherein:
the MIO layer is disposed between the pair of bond layers and transient liquid phase (TLP) bonded to the metal substrate and the semiconductor device; and
each of the pair of bond layers have a melting point above a TLP sintering temperature.

14. The power electronics assembly of claim 9, wherein the MIO layer is electroplate bonded or electroless plate bonded to the metal substrate and the semiconductor device.

15. A process for manufacturing a power electronics assembly comprising:
positioning a thermal stress compensation layer between a metal substrate and a semiconductor device to provide a metal substrate/semiconductor device assembly, the thermal stress compensation layer comprising a metal inverse opal (MIO) layer; and
bonding the MIO layer to the metal substrate and the semiconductor device.

16. The process of claim 15, wherein the thermal stress compensation layer further comprises at least one a pair of bonding layers with the MIO layer disposed between the pair of bonding layers, and the process further comprising:
heating the metal substrate/semiconductor device assembly to a transient liquid phase (TLP) sintering temperature between about 280° C. and 350° C., wherein the at least one pair of bonding layers each have a melting point less than the TLP sintering temperature, and the MIO layer has a melting point greater than the TLP sintering temperature such that the at least one pair of bonding layers at least partially melt and form a TLP bond between the MIO layer and the metal substrate and between the MIO layer and the semiconductor device; and
cooling the power electronics assembly from the TLP sintering temperature, wherein the thermal compensation layer compensates for thermal contraction mismatch between the semiconductor device and the metal substrate during cooling from the TLP sintering temperature to ambient temperature.

17. The process of claim 16, wherein:
the at least one pair of bonding layers comprise a first pair of bonding layers and a second pair of bonding layers:
the first pair of bonding layers are disposed between the MIO layer and the second pair of bonding layers;
each of the first pair of bonding layers have a melting point above the TLP sintering temperature; and
each of the second pair of bonding layers have a melting point below the TLP sintering temperature.

18. The process of claim 15, further comprising placing the metal substrate/semiconductor device assembly in an electroplating bath or an electroless plating bath and electroplate bonding or electroless plate bonding the MIO layer to the metal substrate and the semiconductor device.

19. The process of claim 15, wherein the MIO layer comprises a first surface, a second surface and a graded porosity between the first surface and the second surface.

20. The process of claim 15, wherein the MIO layer comprises a first surface, a second surface and a graded stiffness between the first surface and the second surface.
